(19) United States
(12) Patent Application Publication
(10) Pub. No.: US 2025/0207224 A1
(43) Pub. Date: Jun. 26, 2025

(54) RECYCLED 6XXX ALLOY SHEET AND MANUFACTURING PROCESS

(71) Applicant: CONSTELLIUM NEUF-BRISACH, BIESHEIM (FR)

(72) Inventors: Michael LANGILLE, FONTAINE (FR); Jean-Philippe MASSE, GRENOBLE (FR)

(21) Appl. No.: 18/849,937

(22) PCT Filed: Mar. 31, 2023
(86) PCT No.: PCT/FR2023/050464

§ 371 Date: Sep. 23, 2024

(30) Foreign Application Priority Data
Apr. 2, 2022 (FR) FR2203023

(51) Int. Cl. C22C 21/02; B22D 11/00; B22D 11/041; C22F 1/00; C22F 1/043

(52) U.S. Cl. CPC C22C 21/02; B22D 11/003; B22D 11/041; C22F 1/002; C22F 1/043

(57) ABSTRACT

The invention is an aluminum alloy sheet having the composition Si: 1.25%-1.55%, Fe: <=0.60%, Cu<=0.37%, Mn: 0.22%-0.65%, Mg: 0.25%-0.55%, Ti: <=0.15%, Cr<=0.30%, Cr+Mn+Fe: <=0.90%, Zn: <=0.15%. The alloy in this sheet allows clad sheets, in particular, to be recycled. The sheet offers an outstanding tradeoff between the recycling-related pollution and the properties of corrosion resistance, formability and yield strength both in the T4 state and after paint bake. The invention is also the process for manufacturing the sheet.

### FIELD OF THE INVENTION

The invention relates to the field of aluminum alloy sheets intended for manufacturing, by stamping, bodywork parts of the body-in-white of automobiles.

### PRIOR ART

Aluminum alloys are increasingly being used in automobile construction for reducing the weight of vehicles and thus reducing fuel consumption and greenhouse gas emissions.

It is also necessary to reduce the greenhouse gas emissions during the production of said alloys. This reduction may be obtained by recycling aluminum alloy scrap and waste, which makes it possible to reduce or even avoid the use of primary aluminum produced by electrolysis and/or the addition of alloying elements.

The best electrolysis plants, which use hydroelectricity, have a carbon footprint of 4 tons of CO₂ equivalent (CO₂ eq) per ton of foundry plate taking into account the use of carbon anodes. The typical carbon footprint for one ton of electrolysis aluminum foundry plate produced in Europe is 7 tons of CO₂ eq. The carbon footprint of one ton of foundry plate obtained with only scrap and waste is 0.5 t of CO₂ eq per foundry plate. The CO₂ equivalent emission is the quantity of carbon dioxide (CO₂) emitted that would cause the same integrated radiative forcing, for a time horizon of 100 years, as a quantity emitted by one or more greenhouse gases (GHG). The CO₂ equivalent emission is obtained by multiplying the emission of a GHG by the global warming potential (GWP) thereof for the time horizon of 100 years. In the case of a mixture of GHG, the CO₂ equivalent emission is obtained by adding the CO2 equivalent emissions of each of the gases. When a plate is produced partly using alloys by recycling, the CO₂ equivalent of this plate is evaluated by linear interpolation between an aforementioned electrolysis plate (0% recycling) and a plate obtained with only scrap and waste (100% recycling). Recycling or recycling rate is the ratio of the weight of the aluminum alloy scrap and waste used to produce the plate to the weight of the plate, the remainder of the alloy being primary aluminum and/or alloying elements.

Easy recycling consists in closed loop recycling, that is to say that the aluminum alloy scrap and waste is recycled in order to obtain the same alloy for which it was produced. However, products exist that cannot be recycled in this way. This is the case, in particular, of clad sheets as defined in EN 12258-1 (2012) in § 2.6.26 particularly when they include very different alloys. The clad sheets for producing brazed heat exchangers are in this case because they are in general made of a central part made of 3xxx series alloy sometimes with a little Cu and/or Mg, with one or more claddings made of 4xxx series and/or of 7xxx series and/or of 1xxx series and/or of 3xxx series alloy. Currently, these clad sheets are mainly recycled in casting parts for which the 4xxx series alloys are usually used. Yet, the switch from combustion engine propulsion to electric propulsion will destabilize this recycling branch. Sheets made of aluminum alloy in vehicles, in particular for bodywork and structural parts, are in the prior art in 5xxx and 6xxx alloys which are not suitable for significant recycling of 4xxx series alloys taking into account their composition. The evolution of alloys due to research and development also makes it difficult to recycle old scrap, which is scrap coming from products after their use according to EN 12258-1. This is the case of old scrap coming from the demolition of buildings typically of Si composition: 0.5%, Fe: 0.2%, Cu: 0.1%, Mn: 0.1%, Mg: 0.1%.

The application US20210108293 discloses an aluminum-alloy sheet has a chemical composition containing Si: 2.3-3.8 mass %, Mn: 0.35-1.05 mass %, Mg: 0.35-0.65 mass %, Fe: 0.01-0.45 mass %, and at least one element selected from the group consisting of Cu: 0.0010-1.0 mass %, Cr: 0.0010-0.10 mass %, Zn: 0.0010-0.50 mass %, and Ti: 0.0050-0.20 mass %. The ratio of the Si content to the Mn content is 2.5 or more and 9.0 or less. The aluminum-alloy sheet exhibits an elongation of 23% or more and a strain hardening exponent of 0.28 or more at a nominal strain of 3%. Such an aluminum-alloy sheet is well suited for press forming (stamping) applications, such as forming automobile body panels.

The application WO2018/175876 discloses techniques for casting high-strength and highly formable metal products from recycled metal scrap without the addition of substantial or any amounts of primary aluminum. Additional alloying elements, such as magnesium, can be added to metal scrap, which can be cast and processed to produce a desirable metal coil at final gauge having desirable metallurgical and mechanical properties, such as high strength and formability. Thus, inexpensive and recycled metal scrap can be efficiently repurposed for new applications, such as automotive applications and beverage can stock.

The application JP2005298922 has the problem to be solved of inexpensively providing an aluminum alloy sheet to be formed, which has adequate hem-bending formability, low bending anisotropy and further superior baking hardenability after coating, causes little aging at room temperature and has adequate ridging mark resistance. The solution thereof is an aluminum alloy sheet made of an Al—Mg—Si-based alloy or an Al—Mg—Si—Cu-based alloy; satisfying each condition of (C (sub 1/10)+C(sub 1/4))/2>C(sub 1/2) and 30<(C(sub 1/10)+C(sub ¼))<500, when C(sub 1/10), C(sub ¼) and C(sub ½) are defined as being the cube orientation density at respective positions of 1/10, ¼ and ½ deep from the sheet surface in a sheet thickness direction; has a {001}<210> orientation density in a range of 2 to 50, in a 1/10 to ¼ deep region in the sheet thickness direction; and has 0 degree and 90 degrees earing rates of 5% or higher. The manufacturing method comprises strictly prescribed casting and hot rolling conditions. The conditions for metallographic structures in a cast slab and a sheet after having been hot rolled, which are intermediate products, are prescribed.

The application WO2022/026825 discloses new 6xxx aluminum alloys. In one approach, a new 6xxx aluminum alloy may comprise from 0.25 to 0.60% by weight Fe, 0.8-1.2% by weight Si, 0.35-1.1% by weight Mg, 0.05-0.8% by weight Mn, up to 0.30% by weight Cu, up to 0.35% by weight Zn, up to 0.15% by weight Ti, up to 0.15% by weight each of Cr, Zr and V, the balance being aluminum, incidental elements and impurities. The new 6xxx aluminum alloys may be made from recycled aluminum alloys.

Therefore, there is a need to recycle clad sheet scrap and waster to produce bodywork sheets for the automobile industry.

### Problem Posed

The problem to be solved is to develop a 6xxx series alloy sheet that aims for an outstanding tradeoff between:
The recycling of scrap and waste, preferentially of clad sheets. The clad sheets are in general made with very different alloys, for example a 3xxx series alloy for the central part, 4xxx and/or 7xxx series cladding. The average composition of a clad sheet is difficult to recycle into another sheet because not corresponding to a known alloy. In addition, the recycling activity, in particular when this concerns old scrap coming from products after their use, is indissociable from the pollution phenomenon that results from the mixing with other materials, for example steel, and which may degrade the properties of the materials obtained after recycling.
The formability of the sheet, which is assessed in the T4 state after natural aging, natural aging corresponding to the duration of transport and storage between quenching of the sheet and stamping thereof in the form of a part. Formability is characterized with the LDH (limiting dome height) test for the deformability and with the yield strength for the force to be provided to obtain said deformation.
The properties necessary for the use of the part on an automobile that are assessed on the finished part, therefore after stamping of the sheet, painting and paint bake. Paint bake is also known to the person skilled in the art as “bake hardening”, since it allows at the same time hardening, by aging, of the stamped sheet to obtain the properties necessary for use of the part in an automobile. Suitability for use on an automobile is characterized here by the yield strength of the sheet after deformation of 2% and heat treatment of 170° C. for 20 minutes, representing the paint bake heat treatment. Industrially, the paint bake can last from 10 to 30 minutes at a temperature between 17° and 195° C.
Corrosion, which is assessed on the sheet after natural aging. Corrosion is assessed by a filiform corrosion test of the sheet after a heat treatment of 170° C. for 20 minutes.

### OBJECT OF THE INVENTION

One object of the invention is an aluminum alloy sheet with a composition, as % by weight:
Si: about 1.25%-about 1.55%,
Fe: <=about 0.60%,
Cu: <=about 0.37%,
Mn: about 0.22%-about 0.65%,
Mg: about 0.25%-about 0.55%,
Ti: <=about 0.15%,
Cr<=about 0.30%,
Cr+Mn+Fe: <=about 0.90%,
Zn<=about 0.15%,
other elements: each <=0.05%, together <=0.15%, remainder: Al.

Another object of the invention is a method for manufacturing a rolled sheet of aluminum alloy according to the invention comprising the successive steps of:
a. Producing an alloy, preferentially comprising scrap and waste, preferentially clad sheets,
b. Casting the alloy into a plate, preferentially by semi-continuous vertical casting,
c. Homogenizing the plate at a homogenization temperature, preferentially from 540° C. to 580° C., preferentially higher than 550° C.,
d. Hot rolling the plate,
e. Cold rolling the hot rolled plate,
f. Solution heat treatment then quenching,
g. Pre-aging at a pre-aging temperature of 60 to 100° C. for a period of 2 to 16 hours, preferentially obtained by coiling, then cooling to room temperature,
h. Natural aging from 72 hours to 6 months.

### DESCRIPTION OF THE FIGURES

FIG. 1: This figure shows the LDH depending on the recyclability.

FIG. 2: This figure shows the LDH depending on the Fe, Mn and Cr pollution of the alloy.

FIG. 3: This figure shows the tradeoff between the LDH and the yield strength in the T4 state.

FIG. 4: This figure shows the tradeoff between the LDH and the yield strength after paint bake simulation.

FIG. 5: This figure shows the yield strength in the T4 state depending on the recyclability for the sheets according to the invention.

FIG. 6: This figure shows the yield strength after simulation of the paint bake depending on the recyclability for the sheets according to the invention.

FIG. 7: This figure shows the filiform corrosion results depending on the Cu content.

FIG. 8: This figure shows the LDH measurement tool.

FIG. 9: The sheet according to the invention makes it possible to recycle clad sheets.

FIG. 10: The photograph shows examples of samples subjected to roping lines, of class 1, 2 and 3 (1 average-3 excellent).

### DESCRIPTION OF THE INVENTION

All the aluminum alloys in question hereinafter are, unless specified otherwise, designated according to the rules and designations defined by the “Aluminum Association” in the “Registration Record Series” that it publishes regularly. Unless specified otherwise, the compositions are expressed as % by weight. The expression 1.4 Cu means that the copper content expressed as % by weight is 1.4%.

The metallurgical states in question are designated according to the European standard EN-515.

The static tensile mechanical properties, in other words the ultimate tensile strength Rm, the conventional yield strength at 0.2% elongation Rp0.2, the striction elongation Ag % and the elongation at rupture A % are determined by a tensile test according to NF EN ISO 6892-1, the sampling and the direction of the test being defined by EN 485-1.

The strain-hardening coefficient n is evaluated according to EN ISO 10275.

The modulus of elasticity is measured according to ASTM 1876.

The Lankford coefficient of anisotropy is measured according to EN ISO 10113.

The bending angles, called alpha norm, are determined by 3-point bending test according to NF EN ISO 7438 and the VDA 238-100 and VDA 239-200 version 2017 procedures. Unless specified otherwise, the definitions of the standard EN 12258 apply.

The LDH parameter is widely used for evaluating the suitability of the sheets for stamping. It has been the subject of numerous publications, in particular the one by R. Thompson, “The LDH test to evaluate sheet metal formability-Final Report of the LDH Committee of the North American Deep Drawing Research Group”, SAE conference, Detroit, 1993, SAE Paper no. 930815. It is a case of a test on stamping of a blank locked at the periphery by a ring. The blank-clamping pressure is adjusted to avoid slipping in the ring. The blank, of dimensions 120 mm×160 mm, is stressed in a mode close to planar deformation. The punch used is hemispherical. FIG. 8 specifies the dimensions of the tools used for performing this test. The lubrication between the punch and the sheet is provided by graphited grease. The speed of descent of the punch is 50 mm/min. The so-called LDH value is the value of the movement of the punch at rupture, i.e. the limit depth of the stamping. It corresponds in fact to the mean of three tests, giving a 95% confidence range on the measurement of 0.2 mm.

The standard for measuring intergranular corrosion is ASTM G110.

The standard for filiform corrosion is EN 3665.

Roping lines are measured in the following way. A strip measuring about 270 mm (in the transverse direction) by 50 mm (in the rolling direction) is cut into the sheet. A traction pre-deformation of 15%, perpendicular to the rolling direction, that is to say in the direction of the length of the strip, is subsequently applied. The strip is subsequently subjected to the action of an abrasive paper of the P800 type in order to show the roping lines. The latter is then visually evaluated and translated by classification on a scale of 1 (significant roping lines) to 3 (total absence of roping lines). Examples of roping lines corresponding to the values 1 to 3 are illustrated in FIG. 10.

Room temperature is any temperature compatible with the work of humans from 5 to 35° C. The room temperature may be a temperature of 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C.

The term “about”, when it is used in relation with a measurable numerical variable, refers to the indicated value of the variable and to all the values of the variable that are within the experimental error limits of the indicated value or within the limits of +10 for one hundred of the indicated value, the highest value being retained.

### DETAILED DESCRIPTION

The invention is based on the observation made by the applicant that it is absolutely possible, thanks to a suitable composition and manufacturing process, to produce sheets from recycling clad sheets having an acceptable stampability, a good corrosion resistance and mechanical properties suitable for the production of automobile bodywork

The typical composition of the alloy according to the invention is the following (% by weight):
Si: 1.25%-about 1.55%,
Fe: <=about 0.60%,
Cu: <=about 0.37%,
Mn: 0.22%-about 0.65%,
Mg: about 0.25%-about 0.55%,
Ti: <=about 0.15%,
Cr<=about 0.30%,
Cr+Mn+Fe: <=about 0.90%,
Zn<=about 0.15%,
other elements: each <=0.05%, together <=0.15%, remainder: Al.

The concentration ranges imposed on the constituent elements of this type of alloy are therefore explained by the following reasons:
Si: Silicon is, with magnesium, the prime alloy element of the aluminum-magnesium-silicon systems (Aa6xxx family) to form the intermetallic compounds Mg₂Si or Mg₅Si₆ that contribute to the structural hardening of these alloys. A high Si content favors the recyclability taking into account the use for the cladding of certain sheets clad with an alloy rich in Si such as for example AA4343, AA4045, AA4004 and other alloys the Si content of which makes it possible to reduce the melting point. The Si is in excess in relation to the Mg in weight percentage. Preferentially, the excess of Si is at least 0.70% by weight, more preferably 0.80% by weight and preferably at most 1.20% by weight, more preferably 1.15% by weight. The aim of this excess is to improve the ductility needed for forming the sheet but within the field of the invention, the Si content has little affect on the formability measured by the LDH. The Si content is from 1.25% to about 1.55%. In one embodiment, the Si content is at most about 1.35%, preferably about 1.30%. This embodiment makes a low value of the yield strength in the T4 state possible, which reduces the stamping force. In one embodiment, the Si content is at least about 1.30%, preferably at least about 1.35%, preferably about 1.40%, preferably about 1.45% and/or the maximum is about 1.50%. This embodiment makes it possible to obtain a high value of the yield strength after paint bake.

In one embodiment, the Si content is at least 1.25%, and at most about 1.30% or at most about 1.35% or at most about 1.40% or at most about 1.45% or at most about 1.50% or at most about 1.55%. In one embodiment, the Si content is at least about 1.30%, and at most about 1.35% or at most about 1.40% or at most about 1.45% or at most about 1.50% or at most about 1.55%. In one embodiment, the Si content is at least about 1.35%, and at most about 1.40% or at most about 1.45% or at most about 1.50% or at most about 1.55%. In one embodiment, the Si content is at least about 1.40%, and at most about 1.45% or at most about 1.50% or at most about 1.55%. In one embodiment, the Si content is at least about 1.45%, and at most about 1.50% or at most about 1.55%. In one embodiment, the Si content is at least about 1.50%, and at most about 1.55%.

Fe: Iron is generally considered as an undesirable impurity. The presence of intermetallic compounds containing iron is in general associated with a reduction of the local formability. The maximum Fe iron content is about 0.60%, preferentially about 0.50%, more preferentially about 0.40%. Reducing the Fe content makes it possible to improve the formability measured with the LDH. However, very pure Fe alloys are expensive on the one hand and on the other hand, scrap and waste is naturally polluted by Fe by mixtures with steel. Preferably, the Fe content is therefore at least about 0.05%, preferably about 0.10%, more preferably about 0.15%, more preferably about 0.20%. The Fe content must also be controlled in combination with Mn and Cr taking into account the maximum Cr+Mn+Fe pollutant content: <=about 0.90% to control the LDH of the sheet according to the invention.

In one embodiment, the Fe content is at least about 0.25%, and at most about 0.30% or at most about 0.35% or at most about 0.40% or at most about 0.45% or at most about 0.50% or at most about 0.55% or at most about 0.60%. In one embodiment, the Fe content is at least about 0.30%, and at most about 0.35% or at most about 0.40% or at most about 0.45% or at most about 0.50% or at most about 0.55% or at most about 0.60%. In one embodiment, the Fe content is at least about 0.35%, and at most about 0.40% or at most about 0.45% or at most about 0.50% or at most about 0.55% or at most about 0.60%. In one embodiment, the Fe content is at least about 0.40%, and at most about 0.45% or at most about 0.50% or at most about 0.55% or at most about 0.60%. In one embodiment, the Fe content is at least about 0.45%, and at most about 0.50% or at most about 0.55% or at most about 0.60%. In one embodiment, the Fe content is at least about 0.50%, and at most about 0.55% or at most about 0.60%. In one embodiment, the Fe content is at least about 0.55%, and at most about 0.60%.

Cu: In the alloys of the AA6000 family, copper is an element participating in the hardening precipitation, which is favorable for increasing the yield strength in the T4 state and after paint bake. But Cu is known to degrade the corrosion resistance. The Cu content is at most about 0.37%, preferably about 0.32%, preferably about 0.27%, more preferably 0.25% in order to guarantee an acceptable level of filiform corrosion. Increasing the maximum Cu content makes it possible to improve the recyclability of the clad sheets that contain Cu, for example such as that disclosed by the application WO02/40729. Increasing the Cu content also makes it possible to improve the formability characterized by the LDH test. This effect is advantageous because it makes it possible to improve the pollutant content, in particular Mn, because the Cu content improves the LDH, which makes it possible to compensate the degradation effect of the LDH that results from these pollutants. In one embodiment, the Cu content is therefore at least about 0.20%. In another embodiment, the Cu content is at the maximum value of about 0.20%. This embodiment is advantageous because it makes it possible to avoid adding Cu, which is a metal more expensive than aluminum, for recycling clad sheets that do not contain Cu, such as for example the clad sheets the central part of which is made of AA3003, reference alloy well known to the person skilled in the art of clad sheets.

In one embodiment, the Cu content is at least about 0.05%, and at most about 0.07% or at most about 0.12% or at most about 0.17% or at most about 0.22% or at most about 0.27% or at most about 0.32% or at most about 0.37%. In one embodiment, the Cu content is at least about 0.07%, and at most about 0.12% or at most about 0.17% or at most about 0.22% or at most about 0.27% or at most about 0.32% or at most about 0.37%. In one embodiment, the Cu content is at least about 0.12%, and at most about 0.17% or at most about 0.22% or at most about 0.27% or at most about 0.32% or at most about 0.37%. In one embodiment, the Cu content is at least about 0.17%, and at most about 0.22% or at most about 0.27% or at most about 0.32% or at most about 0.37%. In one embodiment, the Cu content is at least about 0.22%, and at most about 0.27% or at most about 0.32% or at most about 0.37%. In one embodiment, the Cu content is at least about 0.27%, and at most about 0.32% or at most about 0.37%. In one embodiment, the Cu content is at least about 0.32%, and at most about 0.37%.

Mn: Manganese has a similar effect to iron through the contribution thereof to the common intermetallic precipitates. Reducing the Mn content improves the formability measured with the LDH. Increasing the maximum Mn content makes it possible to improve the recyclability of clad sheet scrap and waste. In particular, this makes it possible to increase the recyclability of the clad sheets that contain an alloy with Mn such as AA3003 or the alloy disclosed by the application WO02/40729. A tradeoff is a Mn content of at least 0.22% and of at most 0.65%, preferentially about 0.60%, preferentially 0.55% and preferentially the minimum Mn content is at least about 0.25%, preferentially about 0.30%, preferentially about 0.35%, preferentially about 0.40%, preferentially about 0.44%. The Mn content must also be controlled in combination with Fe and Cr taking into account the maximum Cr+Mn+Fe pollutant content: <=about 0.90% to control the LDH of the sheet according to the invention. Mn may slightly degrade the yield strength in the T4 state, no doubt due to, without this related to the inventors, the pollutant effect thereof.

In one embodiment, the Mn content is at least about 0.22%, and at most about 0.25% or at most about 0.30% or at most about 0.35% or at most about 0.40% or at most about 0.45% or at most about 0.50% or at most about 0.55% or at most about 0.60% or at most about 0.65%. In one embodiment, the Mn content is at least about 0.25%, and at most about 0.30% or at most about 0.35% or at most about 0.40% or at most about 0.45% or at most about 0.50% or at most about 0.55% or at most about 0.60% or at most about 0.65%. In one embodiment, the Mn content is at least about 0.30%, and at most about 0.35% or at most about 0.40% or at most about 0.45% or at most about 0.50% or at most about 0.55% or at most about 0.60% or at most about 0.65%. In one embodiment, the Mn content is at least about 0.35%, and at most about 0.40% or at most about 0.45% or at most about 0.50% or at most about 0.55% or at most about 0.60% or at most about 0.65%. In one embodiment, the Mn content is at least about 0.40%, and at most about 0.45% or at most about 0.50% or at most about 0.55% or at most about 0.60% or at most about 0.65%. In one embodiment, the Mn content is at least about 0.45%, and at most about 0.50% or at most about 0.55% or at most about 0.60% or at most about 0.65%. In one embodiment, the Mn content is at least about 0.50%, and at most about 0.55% or at most about 0.60% or at most about 0.65%. In one embodiment, the Mn content is at least about 0.55%, and at most about 0.60% or at most about 0.65%. In one embodiment, the Mn content is at least about 0.60% and at most about 0.65%.

Mg: Generally, the level of mechanical properties of the alloys of the AA6xxx family increases with the magnesium content combined with silicon to form the intermetallic compounds Mg₂Si or Mg₅Si₆, in particular after annealing the paints, which is beneficial for reducing the thickness of the sheets and making the vehicles lighter. Magnesium contributes to increasing the yield strength in the T4 state, which increases the stamping force, as well as the yield strength after paint bake, which makes it possible to make the bodywork part lighter. In particular, Mg amplifies the response to paint bake, which is the difference between the yield strength after paint bake with the yield strength in the T4 state. Mg is about 0.25% to about 0.55%. In one embodiment, the Mg is at least about 0.30%, preferably about 0.35%, and/or at most about 0.50% preferably about 0.45%. Limiting the Mg content makes it possible to maintain a low yield strength in the T4 state, which is favorable to the formability by avoiding too high stamping forces. In one embodiment, Mg is at least about 0.45%, preferably about 0.50%. Adding Mg makes it possible to improve the response to paint bake and to obtain a higher yield strength after paint bake. Increasing the Mg content makes it possible to improve the recyclability in particular of clad sheets the cladding of which contains Mg, such as for example AA4004 or the central part of which contains Mg such as for example certain alloys disclosed by the patent FR2797454.

In one embodiment, the Mg content is at least about 0.25%, and at most about 0.30% or at most about 0.35% or at most about 0.40% or at most about 0.45% or at most about 0.50% or at most about 0.55%. In one embodiment, the Mg content is at least about 0.30%, and at most about 0.35% or at most about 0.40% or at most about 0.45% or at most about 0.50% or at most about 0.55%. In one embodiment, the Mg content is at least about 0.35%, and at most about 0.40% or at most about 0.45% or at most about 0.50% or at most about 0.55%. In one embodiment, the Mg content is at least about 0.40%, and at most about 0.45% or at most about 0.50% or at most about 0.55%. In one embodiment, the Mg content is at least about 0.45%, and at most about 0.50% or at most about 0.55%. In one embodiment, the Mg content is at least about 0.50%, and at most about 0.55%.

Cr: It can be added to refine the grains and to stabilize the structure. Reducing the Cr content makes it possible to improve the formability measured with the LDH due to the pollutant effect thereof. A high content makes it possible to improve the recyclability of the alloy according to the invention. Indeed, scrap and waste may be polluted by mixtures with steel with Cr. Cr is at most about 0.30%. A tradeoff between the formability and the recyclability is Cr+M+Fe<=about 0.90%. In one embodiment, in order to improve the formability, Cr is at most about 0.20%, preferably about 0.15%, preferably about 0.10%, preferentially about 0.05%. In one embodiment, Cr is an impurity.

Ti: A maximum content of about 0.15%, preferentially 0.10% is required to avoid the conditions for forming primary phases during vertical casting, which have a detrimental effect on all of the claimed properties. This element can favor hardening by solid solution leading to the required level of mechanical characteristics and this element also has a favorable effect on ductility in service and resistance to corrosion. In one embodiment, the Ti content is at most about 0.01%,

In one embodiment, the Ti content is at most about 0.05% or at most about 0.10% or at most about 0.15%. In one embodiment, the Ti content is at least about 0.01%, and at most about 0.05% or at most about 0.10% or at most about 0.15%.

Zn: The content is at most about 0.15%. As Zn is an alloying element in aluminum alloys, it is advantageous to accept it for the purpose of recycling aluminum scrap and waste, in particular of end-of-life vehicles. Indeed, Zn is used in certain cladding alloys of certain clad sheets, in particular AA7072 with a cladding of 10% of thickness. Another cladding alloy containing Zn is disclosed by the application WO02/55256. Taking into account the Zn content of AA7072 or of the alloy of the aforementioned application, this content is not limited to the use of such clad sheets for producing the alloy according to the invention. However, Zn is renowned for creating a sensitivity to corrosion. Limiting the Zn content may therefore improve the corrosion resistance. In a preferred embodiment, Zn is at most about 0.10%. In one embodiment, Zn is at most about 0.05%. In one embodiment, Zn is an impurity.

The other elements are typically impurities, the content of which is maintained less or equal to 0.05%, preferentially strictly less than 0.05%, together being less than 0.15%, the remainder is aluminum.

The pollution content made of Fe, Mn and Cr must be controlled. The term pollution is used to indicate that these elements may in some cases be present in the alloy according to the invention due to the recycling. However, without them being related to a theory, the present inventors observe that the effect of these elements is not detrimental and could have an unexpected favorable effect on the properties obtained in the claimed proportions. Increasing the pollution content makes it possible to increase the recyclability. Reducing the pollution content makes it possible to increase the LDH. Preferentially, a tradeoff is a pollutant content from at least about 0.64% to at most about 0.90%. In one embodiment, the pollutant content is from about Cu +0.41% to about Cu +0.59%, preferentially from about 0.45%+Cu to about 0.55%+Cu. This embodiment is advantageous because it makes it possible to maintain a high LDH value. In a more preferred embodiment, the pollutant content is higher than about 0.70%, which makes it possible to increase the recyclability for clad sheets containing copper.

In one embodiment, the sheet according to the invention has an LDH less than or equal to 26.0 mm. The LDH is measured with a 1 mm thick sheet in the T4 state. Limiting the LDH is a tradeoff that makes it possible to improve the recyclability of the sheet according to the invention. Limiting the LDH is a tradeoff that makes it possible to increase the quantity of pollutants in the sheet according to the invention. Limiting the LDH is a tradeoff that makes it possible to increase the yield strength of the sheet according to the invention both in the T4 state and after paint bake. In one embodiment, the sheet according to the invention has an LDH higher than or equal to 24.0 mm preferentially higher than or equal to 24.5 mm, more preferentially higher than or equal to 25.0 mm, more preferentially higher than or equal to 25.5 mm. Increasing the value of the LDH makes it possible to increase the formability to stamping.

In one embodiment, the sheet according to the invention has a minimum yield strength Rp0.2 in the T4 state of 100 MPa, preferably 110 MPa, more preferably 115 MPa and/or has a maximum yield strength Rp0.2 in the T4 state of 150 MPa, preferably 145 MPa, more preferably 140 MPa. Too low a yield strength in the T4 state will limit the yield strength after paint bake. Too high a yield strength in the T4 state increases the stamping force. Limiting the maximum yield strength in the T4 state is a tradeoff that makes it possible to improve the formability measured with the LDH. In one sub-embodiment, the yield strength Rp0.2 in the T4 state is at most 135 MPa. This sub-embodiment is a tradeoff that makes it possible to increase the recyclability.

In one embodiment, the sheet according to the invention has a minimum yield strength Rp0.2 after paint bake of 200 MPa, preferably 210 MPa and/or has a maximum yield strength Rp0.2 after paint bake of 250 MPa, preferably 240 MPa. Increasing the yield strength after paint bake is advantageous for reducing the thickness of the parts. In one sub-embodiment, the yield strength after paint bake is at most 220 MPa, preferably 215 MPa. This sub-embodiment is a tradeoff that makes it possible to increase the recyclability.

In a preferred embodiment, the sheet according to the invention has an outstanding resistance to filiform corrosion less than about 0.25 cm on average according to EN 3665 after painting and paint bake. Painting includes all the operations known per se of surface preparation, cataphoresis then painting. Paint bake, also known under the term bake hardening, can be simulated by a treatment at 170° C. for 20 minutes.

The process for manufacturing sheets according to the invention includes the casting of a plate, preferentially by vertical semi-continuous casting followed by homogenization thereof.

The plate is cast with an alloy according to the previously described composition. The alloy is preferentially produced partly with scrap and waste, preferably clad sheets. This clad sheet scrap and waste may also be a finished product to be recycled (old scrap according to EN 12258-1) a part of which is made with a clad sheet. This is advantageous because these finished products are generally also made with very different alloy parts, without all the components necessarily being clad, for example 3xxx series alloys with alloys containing Zn, for example of the 7xxxx series or for example disclosed by the application EP1446511. Clad sheet scrap and waste can be used to produce the alloy either directly or indirectly. Indirect use is advantageous when the clad sheet scrap and waste is coated with paint or varnish, or when the clad sheet scrap and waste is equipped with plastic parts. In these cases, it is preferable to remelt it in specialist units, known by the person skilled in the art of recycling, where the coating or the plastic parts will be treated correctly, for example by filtering the fumes. Direct use is advantageous because it is easy and economical to organize because it consists in loading the scrap and waste directly into the melting furnaces to produce the alloy.

The recyclability is evaluated in the following way. First, it is necessary to calculate, estimate or measure the average composition of the scrap or waste, preferentially of clad sheets, for each element. Then, for each element, the percentage ratio of the maximum of the alloy of the sheet according to the invention to the content of the element in the average composition of clad sheet scrap and waste is calculated. The recyclability is the minimum value between all these ratios. This recyclability is therefore the maximum of clad sheet scrap and waste that can be added in the alloy of the sheet according to the invention, the composition of the alloy of the sheet according to the invention being obtained by adding primary aluminum and/or alloying elements.

Increasing the recyclability makes it possible to reduce the quantity of CO₂ equivalent emitted to cast the plate. Preferentially, the plate is produced with at least 10% of scrap and waste, preferentially at least 20%, preferentially at least 30%, preferentially at least 39%, preferentially at least 46%, preferentially at least 48%. In one embodiment, recyclability at most of 45% is a tradeoff that makes it possible to improve the yield strength in the T4 state or after paint bake.

The preferential dimensions of the plates according to the invention are 200 mm to 600 mm in thickness, 1,000 to 3,000 mm in width and 2,000 to 8,000 mm in length.

The plate is typically homogenized to a homogenization temperature above the solvus temperature of the alloy, while avoiding local melting or incipient melting for a minimum period of 2 hours, preferentially 3 hours, more preferentially 4 hours and at most 7 hours, preferentially 6 hours, more preferentially 5 hours. The homogenization temperature is preferentially at most 580° C., preferentially 570° C., more preferentially 560° C., more preferentially 555° C., and at least 540° C., preferentially 550° C., too high or too low a temperature degrades the mechanical properties of the sheet.

The plate is subsequently transferred to the hot roller. Optionally, it is transferred directly from homogenization to hot rolling, the temperature able to be reduced from 5 to 35° C. naturally during this transfer. Optionally, the plate is cooled from the homogenization temperature to the temperature of start of hot rolling by forced cooling. This forced cooling is preferentially performed with a direct cooling rate of at least 150° C. per hour. Advantageously, the direct cooling rate is at most 500° C./hour. The cooling can typically be implemented by a machine such as the one described by the application WO2016012691. Preferentially, this cooling is done in two steps, one of spraying and the other of uniformization. Optionally, this cooling can be implemented in two passes through a machine such as the one described by the application WO2016012691.

The homogenized plate is subsequently hot rolled typically to a thickness of 4, preferentially 3 mm, to 8 mm. The temperature of start of hot rolling is typically 520 to 550° C. Optionally, the hot rolling temperature after the aforementioned cooling is 390° C. to 510° C. or 490° C. or 470° C. or 450° C. or 430° C. or 410° C. Optionally, the hot rolling temperature after the aforementioned cooling is 410° C. to 510° C. or 490° C. or 470° C. or 450° C. or 430° C. Optionally, the hot rolling temperature after the aforementioned cooling is 430° C. to 510° C. or 490° C. or 470° C. or 450° C. Optionally, the hot rolling temperature after the aforementioned cooling is 450° C. to 510° C. or 490° C. or 470° C. Optionally, the hot rolling temperature after the aforementioned cooling is 470° C. to 510° C. or 490° C. Optionally, the hot rolling temperature after the aforementioned cooling is 490° C. to 510° C.

The evolution of the temperature between the start and the end of the hot rolling results from the cooling by normal heat exchange of the plate with the air at room temperature of the plant, with the hot equipment of the rolling mill such as for example, non-limitatively, the cylinders of the conveying rollers, as well as with the usual lubrication or cooling fluids and heating related to the deformation energy. Preferentially, the temperature of end of hot rolling is 350° C. to 450° C.

The hot rolled plate is subsequently cold rolled, typically into a sheet of 0.7 to 1.5 mm. Intermediate annealing may also take place between two cold-rolling steps. The annealing may take place in a static furnace or in a continuous furnace.

The sheet is subsequently solution heat treated at a solution temperature above the solvus temperature of the alloy, while avoiding local melting or incipient melting then quenched, preferentially in a continuous furnace. Solution heat treatment that is too cold and/or solution heat treatment for too short a time degrades the mechanical properties of the sheet by insufficient solution heat treatment. Solution heat treatment that is too hot causes incipient melting degrading the mechanical properties. Solution heat treatment for too long degrades the productivity. Preferably, solution heat treatment lasts from 15 seconds to 300 s. The solution heat treatment temperature is preferentially at least 530° C. and at most 570° C.

Subsequently, the sheet is quenched typically at a rate of more than 30° C./s and best at least 100° C./s with water or with air or with a successive combination of water or air. Preferentially, the sheet is quenched to a temperature of 60 to 100° C. An insufficient cooling speed degrades the mechanical properties of the sheet because solution heat treatment is then incomplete.

The sheet is subsequently heated to perform pre-aging at a pre-aging temperature of 60° C. to 100° C. for a period of 2 to 16 hours. Heating is useful when the sheet is subjected between quenching and pre-aging to a surface treatment the temperature of which is lower than the pre-aging. Preferentially, pre-aging is obtained by coiling then cooling to room temperature, preferentially for at least 40 hours. Pre-aging makes it possible to improve the response to paint bake, which is the difference between the yield strength in the T4 state and the yield strength after paint bake.

The pre-aged sheet is in the T4 state and subsequently ages naturally at room temperature between 72 hours and 6 months. This step is a constraint related to storage before forming. The sheet according to the invention may be formed despite natural aging.

The sheet according to the invention is advantageously used to produce automobile body parts. In one embodiment, the sheet according to the invention is a sheet for lining, such as for example door or boot linings. For automobile parts, in particular linings, the thicknesses are from 0.7 to 1.5 mm. A thickness less than 0.7 mm is too thin to ensure the rigidity of the component that contains the lining. A thickness greater than 1.5 mm makes the component that contains the lining too heavy for the user and the vehicle. As the linings are not parts visible from outside of the vehicle, the sheets for linings do not have a surface condition in the delivery state and after painting comparable to that of the external parts for the bodywork of the vehicle. In one embodiment, the roping lines of the sheet according to the invention at best 1.

### Examples

The disclosure is also illustrated further by the following examples. These examples are only intended to illustrate the invention and not to limit it.

Plates of various compositions were cast according to the alloys in Table 1. Alloy A is an alloy typical of the application US20210108293. Alloy B is a typical production alloy for providing bodywork sheets made of AA6016 alloy. The examples according to the invention are identified E and the counter-examples by CE in Table 1.

TABLE 1

| | | | | | | | | | | Fe + |
|---|---|---|---|---|---|---|---|---|---|---|
| | | Si | Fe | Cu | Mn | Mg | Cr | Ti | Zn | Mn + Cr |
| A | CE | 2.32 | 0.29 | 0.18 | 0.49 | 0.48 | 0.01 | 0.05 | | 0.78 |
| B | CE | 1.11 | 0.22 | 0.13 | 0.12 | 0.44 | 0.01 | 0.05 | | 0.35 |
| C | CE | 1.54 | 0.24 | 0.42 | 0.55 | 0.38 | 0.01 | 0.06 | | 0.80 |
| D | CE | 1.49 | 0.25 | 0.19 | 0.56 | 0.70 | 0.01 | 0.05 | | 0.81 |
| E | CE | 1.56 | 0.23 | 0.64 | 0.54 | 0.38 | 0.01 | 0.06 | | 0.78 |
| F | CE | 1.51 | 0.25 | 0.42 | 0.56 | 0.73 | 0.01 | 0.05 | | 0.83 |
| G | CE | 1.89 | 0.24 | 0.42 | 0.89 | 0.42 | 0.01 | 0.05 | | 1.14 |
| H | CE | 1.50 | 0.49 | 0.17 | 0.59 | 0.41 | 0.01 | 0.05 | | 1.09 |
| I | CE | 1.47 | 0.49 | 0.38 | 0.58 | 0.41 | 0.05 | 0.05 | | 1.12 |
| J | CE | 1.91 | 0.24 | 0.61 | 0.53 | 0.41 | 0.01 | 0.05 | | 0.78 |
| K | E | 1.28 | 0.23 | 0.25 | 0.52 | 0.35 | 0.001 | 0.01 | <0.01 | 0.75 |
| L | E | 1.47 | 0.23 | 0.24 | 0.52 | 0.34 | 0.001 | 0.01 | <0.01 | 0.75 |
| M | E | 1.48 | 0.24 | 0.20 | 0.44 | 0.36 | 0.001 | 0.01 | <0.01 | 0.68 |
| N | E | 1.27 | 0.24 | 0.20 | 0.44 | 0.45 | 0.001 | 0.01 | <0.01 | 0.68 |
| O | E | 1.41 | 0.26 | 0.18 | 0.50 | 0.37 | 0.010 | 0.05 | | 0.77 |
| P | E | 1.39 | 0.26 | 0.23 | 0.49 | 0.38 | 0.010 | 0.05 | | 0.76 |

The recyclability was evaluated with a clad sheet as disclosed by the application WO02/40729 by selecting a cladding on each face of the core of 10%. With a view to recycling such a sheet, the average composition of the clad sheet is calculated in the table below.

TABLE 2

| | Si | Fe | Cu | Mn | Mg | Cr | Ti | Zn |
|---|---|---|---|---|---|---|---|---|
| central part | 0.19 | 0.19 | 0.62 | 1.33 | 0.01 | 0.002 | 0.09 | 0.039 |
| cladding | 7.21 | 0.25 | | 0.08 | | | | |
| average | 1.59 | 0.20 | 0.50 | 1.08 | 0.01 | 0.002 | 0.07 | 0.03 |
| composition | | | | | | | | |

The recyclability of the various alloys A to P is evaluated by calculating the maximum quantity of the average composition calculated in Table 2 below for each element. A value higher than 100% means that the clad sheet does not provide the quantity of the element considered, therefore that nothing limits the introduction of the clad sheet to produce the alloy for the element considered. A value lower than 100% implies that the clad sheet provides too much of the element considered and that the introduction of the clad sheet must be limited to produce the alloy. Therefore, it is necessary to only take into account the minimum over all the elements for each alloy evaluated in order to define the recyclability thereof. For Cr and Ti, calculating the recyclability is not done with the Ti and Cr content of the alloys tested but with the value of 0.05% that corresponds to the conventional maximum of 0.05% of the impurities.

TABLE 3

| | Si | Fe | Cu | Mn | Mg | Cr | Ti | recyclability |
|---|---|---|---|---|---|---|---|---|
| A | >100% | >100% | 36% | 45% | >100% | >100% | 69% | 36% |
| B | 70% | >100% | 25% | 11% | >100% | >100% | 69% | 11% |
| C | 94% | 100% | 84% | 51% | >100% | >100% | 69% | 51% |
| D | 94% | 100% | 38% | 52% | >100% | >100% | 69% | 38% |
| E | >100% | 100% | >100% | 50% | >100% | >100% | 69% | 50% |
| F | 94% | >100% | 84% | 52% | >100% | >100% | 69% | 52% |
| G | >100% | 100% | 84% | 82% | >100% | >100% | 69% | 69% |
| H | 94% | >100% | 35% | 54% | >100% | >100% | 69% | 35% |
| I | >100% | 100% | >100% | 49% | >100% | >100% | 69% | 49% |
| J | 94% | >100% | 76% | 54% | >100% | >100% | 69% | 54% |
| K | 81% | >100% | 49% | 48% | >100% | >100% | 69% | 48% |
| L | 92% | >100% | 48% | 48% | >100% | >100% | 69% | 48% |
| M | 93% | >100% | 40% | 41% | >100% | >100% | 69% | 40% |
| N | 80% | >100% | 39% | 41% | >100% | >100% | 69% | 39% |
| O | 89% | >100% | 36% | 46% | >100% | >100% | 71% | 36% |
| P | 87% | >100% | 46% | 45% | >100% | >100% | 71% | 45% |

The plates A to N were homogenized at the temperature of 555° C. for 4 hours, then hot rolled at a thickness of 6 mm with a temperature of start of hot rolling of 550° C. then cold rolled into 1 mm thick sheets. These sheets were subsequently solution heat treated at a temperature higher than 530° C. for 15 s then quenched to the temperature of 60° C. The sheets were subsequently pre-aged at 80° C. for 16 hours.

The plates O and P were homogenized for 2 hours at 560° C. then they were cooled by forced cooling at the temperature of start of hot rolling of 400° C. The plate is cold rolled to a thickness of 3 mm at a temperature of 305° C. The plate was subsequently cold rolled to a thickness of 1.2 mm then solution heat treated with a PMT (peak metal temperature) of 560° C. then quenched. Pre-aging is subsequently performed by heating to the temperature of 65° C., then by coiling which subsequently naturally cools to room temperature.

The mechanical properties were tested in the T4 state. The results are shown in Table 4. The last column is the yield strength of these samples after 7 days of natural aging after paint bake simulation (Bake hardening or BH) with a heat treatment of 170° C. for 20 minutes. The TL direction is the direction transverse to the rolling direction.

TABLE 4

| | | | | | | | BH, TL |
|---|---|---|---|---|---|---|---|
| | | Natural | T4, TL direction | | | | direction |
| | | aging | LDH | Rp0.2 | Ag | A | Rp0.2 |
| Ref | | (day) | (mm) | (MPa) | (%) | (%) | (MPa) |
| A | CE | | 24.1 | 150 | 21.3 | 24.9 | 240 |
| B | CE | 7 | 26.1 | 124 | 23.9 | 27.3 | 215 |
| C | CE | 7 | 23.7 | 123 | 22.0 | 24.8 | 211 |
| D | CE | 7 | 24.4 | 166 | 22.1 | 25.5 | 256 |
| E | CE | 7 | 24.2 | 130 | 22.6 | 25.8 | 214 |
| F | CE | 7 | 24.1 | 166 | 22.9 | 26.3 | 254 |
| G | CE | 7 | 23.8 | 135 | 20.3 | 22.8 | 230 |
| H | CE | 7 | 23.9 | 140 | 22.0 | 25.6 | 237 |
| I | CE | 7 | 23.3 | 131 | 21.2 | 23.3 | 223 |
| J | CE | 7 | 24.4 | 146 | 21.6 | 24.4 | 227 |
| K | E | 7 | 25.6 | 119 | 22.8 | 25.9 | 211 |
| L | E | 7 | 25.6 | 131 | 23.5 | 27.3 | 217 |
| M | E | 7 | 25.9 | 136 | 23.9 | 27.8 | 218 |
| N | E | 7 | 25.6 | 138 | 23.2 | 26.8 | 238 |
| O | E | 13 | 24.9 | 117 | 21.7 | 25.6 | 202 |
| P | E | 13 | 24.8 | 120 | 21.6 | 25.1 | 207 |

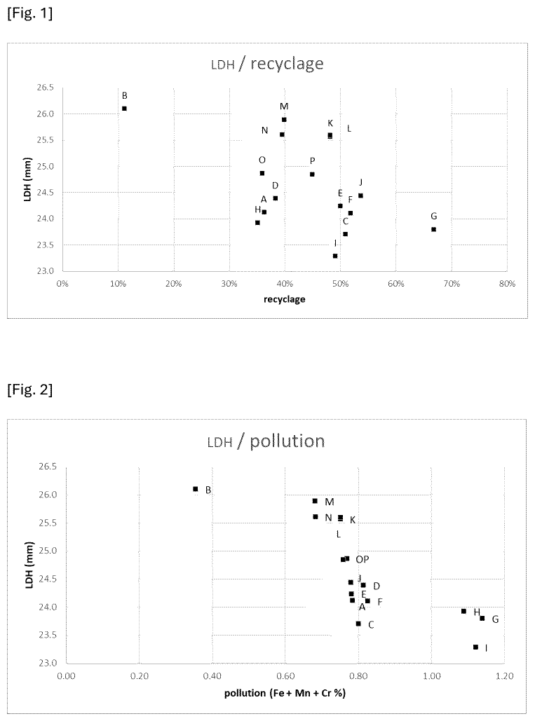

FIG. 1 shows that the sheets according to the invention K, L, M, N, O and P are a good tradeoff between the formability and the recyclability. Indeed, the sheet B is a little better in formability but with a very low recyclability. The other sheets may have a better recyclability but with a substantially reduced formability.

FIG. 2 shows that the sheets according to the invention K, L, M, N, O and P are a good tradeoff between the formability and the Fe, Cr and Mn pollution level. Indeed, the sheet B is a little better in formability but with a high purity alloy with a low pollution content. The other sheets contain a higher Fe, Cr and Mn pollutant content but with a substantially reduced formability.

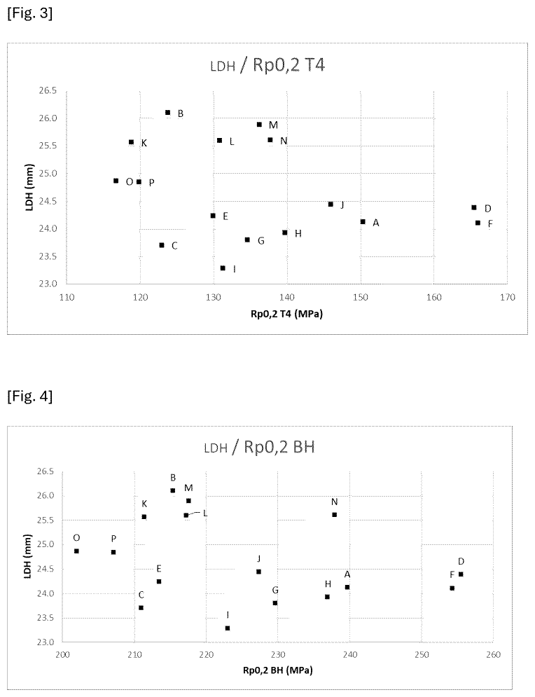

FIGS. 3 and 4 show that the sheets according to the tradeoff between LDH (formability) and Rp0.2 in the T4 state (forming force) and between LDH and Rp0.2 after paint bake simulation (BH or bake hardening). The sheets K, L, M, N, O and P have a better tradeoff than the other sheets (except for the sheet B but the sheet B is not according to the invention due to the low content thereof in one of the pollutants which is Mn). The sheets K and L have a formability level similar to the sheets M and N thanks to the Cu content that compensates the Mn+Cr+Fe pollution level.

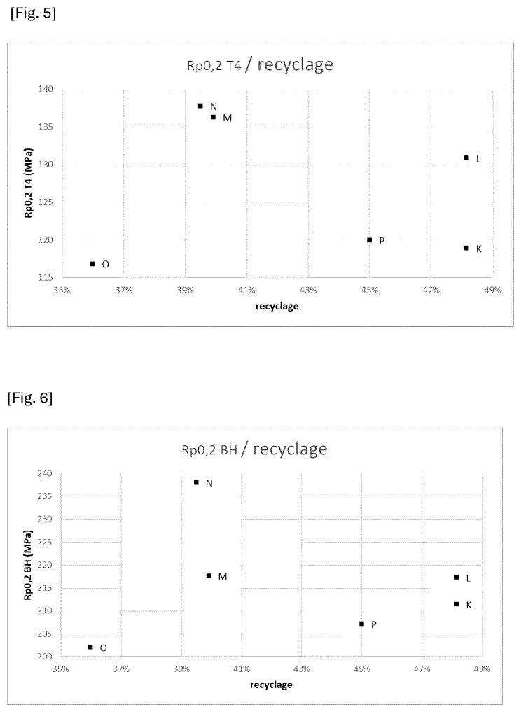

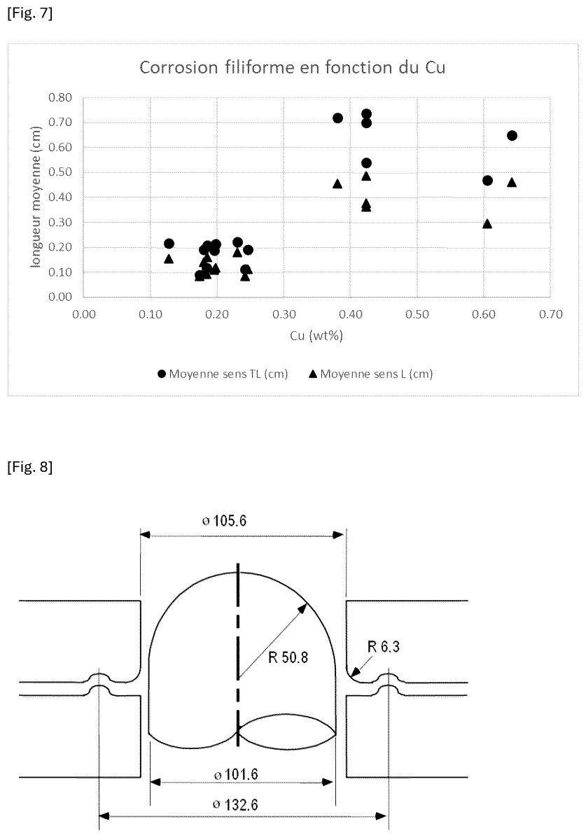

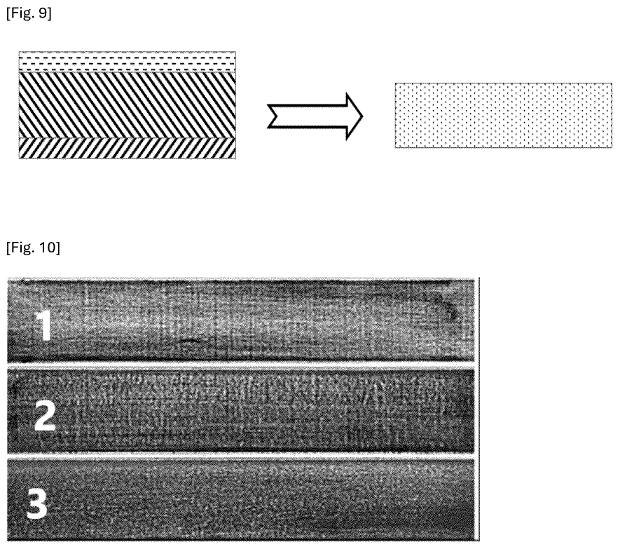

FIG. 5 shows two different advantageous tradeoffs between recyclability and yield strength in the T4 state and after paint bake. The sheet N has better yield strengths in the T4 state and after paint bake and a slightly lower recyclability. The sheet L has a better recyclability and a slightly lower yield strengths in the T4 state and after paint bake.

The sheets K and L have a better recyclability thanks to a higher Mn content than the sheets M and N.

The sheet N makes it possible to obtain the best yield strength after paint bake by increasing the Mg compared to the sheet M while maintaining a yield strength in the T4 state comparable to the sheet M by reducing the Si content. The Mn content less than 0.50% makes it possible to compensate for the hardening effect in the T4 state to maintain the LDH level.

The sheets A to P were subjected to a filiform corrosion test in accordance with the standard EN3665. To this end, the samples were subjected to surface and painting treatments known by the person skilled in the art. The samples were subsequently subjected to paint bake heat treatment of 170° C. for 20 minutes. The samples were subsequently scratched in the rolling longitudinal direction (L) and the long transverse direction, perpendicular to the rolling direction. (TL). The results of the filiform corrosion test are given in the table below.

TABLE 5

| | TL direction | L direction |
|---|---|---|
| Ref | average (cm) | average (cm) |
| A | 0.12 | 0.09 |
| B | 0.22 | 0.16 |
| C | 0.54 | 0.36 |
| D | 0.21 | 0.16 |
| E | 0.65 | 0.46 |
| F | 0.74 | 0.49 |
| G | 0.70 | 0.38 |
| H | 0.09 | 0.08 |
| I | 0.72 | 0.46 |
| J | 0.47 | 0.29 |
| K | 0.19 | 0.11 |
| L | 0.11 | 0.08 |
| M | 0.21 | 0.12 |
| N | 0.19 | 0.11 |
| O | 0.19 | 0.14 |
| P | 0.22 | 0.18 |

Only the samples A, B D, H, K, L M, N, O and P, the copper content of which is less than 0.37%, have a corrosion behavior to filiform corrosion with an average length less than 0.25 cm.

The sheets B, H, K, L M, N, O and P have also been characterized after a natural aging of 90 days. The sheets remain not very sensitive to the natural aging.

TABLE 6

| | T4, T direction, natural aging of 90 days | | | | BH, T direction |
|---|---|---|---|---|---|
| | Rp0.2 (MPa) | Rm (MPa) | Ag (%) | A (%) | BH Rp0.2 |
| B | 142 | 269 | 23.3 | 28.5 | 210 |
| H | 152 | 296 | 21.4 | 26.5 | 231 |
| K | 131 | 271 | 22.0 | 26.0 | 209 |
| L | 140 | 281 | 22.9 | 27.5 | 209 |
| M | 144 | 284 | 22.8 | 27.3 | 213 |
| N | 150 | 289 | 22.5 | 27.0 | 228 |
| O | 133 | 263 | 20.9 | 25.3 | 196 |
| P | 137 | 269 | 21.0 | 25.7 | 201 |

The invention claimed is:

1. An aluminum alloy sheet having the composition, as % by weight:
Si: 1.25%-about 1.55%,
Fe: <=about 0.60%,
Cu: <=about 0.37%,
Mn: 0.22%-about 0.65%,
Mg: about 0.25%-about 0.55%,
Ti: <=about 0.15%,
Cr<=about 0.30%,
Cr+Mn+Fe: <=about 0.90%,
Zn<=about 0.15%,
other elements: each <=0.05%, together <=0.15%,
remainder: Al.

2. The sheet according to claim 1 wherein Cu <=about 0.32%, optionally about <=0.27%, optionally <=0.25%.

3. The sheet according to claim 1 wherein Mn>=about 0.30%, optionally about >=0.35%, optionally about >=0.40%, and/or Mn about <=0.60%, optionally about <=0.55%.

4. The sheet according to claim 1, wherein Mg>=about 0.30%, optionally about >=0.35% and/or Mg<=about 0.50%, optionally about <=0.45%.

5. The sheet according to claim 1, wherein Cr<=about 0.15%, optionally<=about 0.10%, optionally<=about 0.05%.

6. The sheet according to claim 1, wherein Ti<=about 0.10%, optionally Ti<=about 0.05% or Ti>=about 0.01%.

7. The sheet according to claim 1, wherein Zn<=about 0.10%, optionally Zn<=about 0.05%.

8. The sheet according to claim 1, wherein Si<=about 1.50% and/or >=about 1.30%; optionally about >=1.35%, optionally about >=1.40%.

9. The sheet according to claim 1, wherein the sheet has an LDH less than or equal to 26.0 mm and/or higher than or equal to 24.0 mm, optionally higher than or equal to 24.5 mm, optionally higher than or equal to 25.0 mm, the LDH being measured with a sheet of thickness of 1 mm in the T4 state.

10. The sheet according to claim 1, wherein the sheet has a minimum yield strength Rp0.2 in the T4 state of 100 MPa, optionally 110 MPa, optionally 115 MPa and/or has a maximum yield strength Rp0.2 in the T4 state of 150 MPa, optionally 145 MPa, optionally 140 MPa.

11. A process for manufacturing the sheet according to claim 1 comprising successively
a. Producing an alloy, optionally comprising scrap and waste, optionally clad sheets,
b. Casting the alloy into a plate, optionally by semi-continuous vertical casting,
c. Homogenizing the plate at a homogenization temperature, optionally from 540° C. to 580° C., optionally from 550° C. to 580° C.,
d. Hot rolling the plate,
e. Cold rolling the hot rolled plate,
f. Solution heat treatment then quenching,
g. Pre-aging at a pre-aging temperature of 60 to 100° C. for a period of 2 to 16 hours, optionally obtained by coiling, then cooling to room temperature,
h. Natural aging from 72 hours to 6 months.
